(19) United States
(12) Patent Application Publication
(10) Pub. No.: US 2021/0344155 A1
(43) Pub. Date: Nov. 4, 2021

(54) ELECTRICAL CABLE HAVING AT LEAST ONE CONSOLIDATED END

(71) Applicant: ELCo Enterprises, Inc., Jackson, MI (US)

(72) Inventors: Edward L. Cooper, Clarklake, MI (US); Alexander KHAKHALEV, Ann Arbor, MI (US)

(21) Appl. No.: 17/261,686

(22) PCT Filed: Jul. 16, 2019
(86) PCT No.: PCT/US2019/041963

§ 371 Date: Jan. 20, 2021

Related U.S. Application Data
(60) Provisional application No. 62/701,105, filed on Jul. 20, 2018.

(51) Int. Cl. H01R 43/02; H01R 13/02

(52) U.S. Cl. CPC H01R 43/0207; H01R 13/025

(57) ABSTRACT

An electrical cable having at least one consolidated end may be made of a multi-stranded conductor or a plurality of conductive leaves. At least one end of the multi-stranded conductor or plurality of conductive leaves is ultrasonically welded together. The end of the multi-stranded conductor or plurality of conductive leaves ultrasonically welded together may further include a sleeve or cap substantially enclosing the end of the multi-stranded conductor or plurality of conductive leaves.

### RELATED APPLICATIONS

This application claims the benefit of U.S. Provisional Patent Application No. 62/701,105 filed Jul. 20, 2018, the content of which is hereby incorporated by reference in its entirety.

### BACKGROUND

### 1. Field of the Invention

The present invention generally relates to electrical conduits for transmitting electricity from one location to another.

### 2. Description of Related Art

Ampacity is defined as the maximum amount of electric current a conductor or cable can carry before sustaining immediate or progressive deterioration. The ampacity of a cable depends on several factors including, for example, the cable's ability to dissipate heat without damage to the conductor located within the cable or its insulation (if applicable). This is a function of the insulation temperature rating, the electrical resistance of the conductor material, the ambient temperature, and the ability of the insulated conductor to dissipate heat to the surrounds.

All common electrical conductors for cables have some resistance to the flow of electricity. Electric current flowing through them causes a voltage drop and power dissipation, which heats conductors. Copper or aluminum can conduct a large amount of current without damage, but long before conductor damage, insulation would, typically, be damaged by the resultant heat.

The ampacity for a conductor is generally based on physical and electrical properties of the material and construction of the conductor and of its insulation, ambient temperature, and environmental conditions adjacent to the conductor. Having a large overall surface area can dissipate heat well if the environment can absorb the heat.

However, materials such as copper are fairly expensive. Additionally, a conductor with a large surface area significantly adds weight to the cable. This additional weight can cause issues especially in applications where the cable is routinely moved around. For example, for electric vehicle charging stations or gas metal arc welding systems, the electrical cable may be moved significantly depending on the application. Furthermore, because of this movement, a cable using a multi-stranded conductor will most likely be used. Over time, the ends of the multi-stranded conductor may become corroded and require maintenance or replacement.

### SUMMARY

An electrical cable having at least one consolidated end may be made of a multi-stranded conductor or a plurality of conductive leaves. At least one end of the multi-stranded conductor or plurality of conductive leaves is ultrasonically welded together. The end of the multi-stranded conductor or plurality of conductive leaves ultrasonically welded together may further include a sleeve or cap enclosing the end of the multi-stranded conductor or plurality of conductive leaves. The ultrasonic welding process may occur either before or after the sleeve or cap is applied to the end of the multi-stranded conductor or plurality of conductive leaves. In a situation where the sleeve or cap is applied before the ultrasonic welding process, the sleeve or cap will be ultrasonically welded to the end of the multi-stranded conductor or plurality of conductive leaves. As such, the sleeve or cap along with the multi-stranded conductor or plurality of conductive leaves will be ultrasonically welded together.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIGS. 1A-1C illustrate a multi-stranded cable having consolidated ends;

FIGS. 2A-2C illustrate two multi-stranded cables having consolidated ends that have been ultrasonically welded together; and

FIGS. 3A-3C illustrate a shunt cable having consolidated ends.

### DETAILED DESCRIPTION

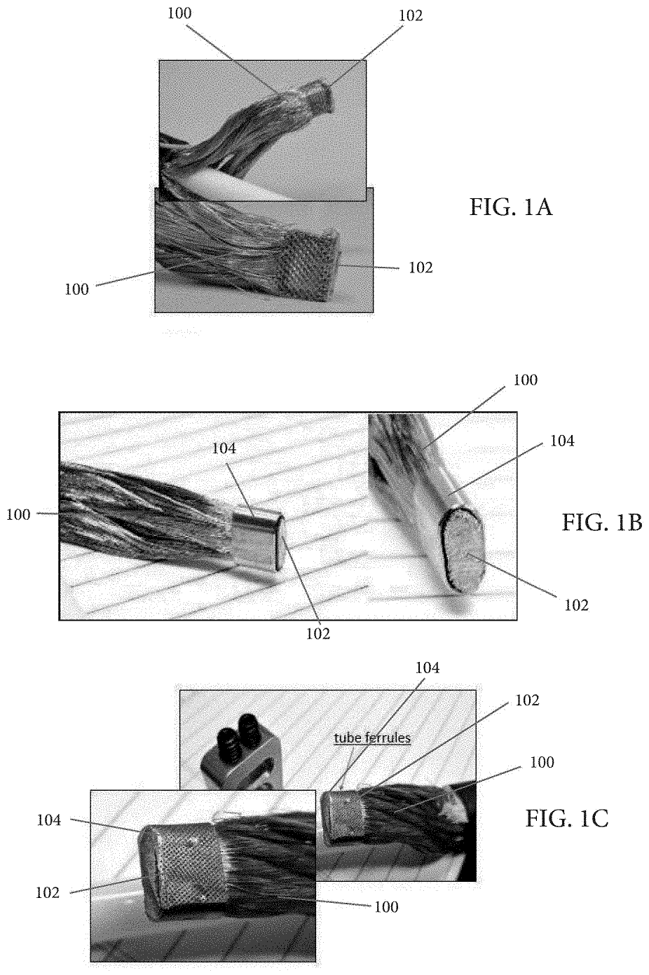

Referring to FIGS. 1A-1C, a cable 100 is shown and may be any type of conductive wire but generally is a multi-stranded copper wire. The cable 100 has at least one terminal end 102. The strands of the cable 100 at the terminal end 102 may be consolidated with each other via the use of the welding process. This welding process may be an ultrasonic welding process that welds the terminal end 102 of the cable 100.

The shape of the welded terminal end 102 may take any one of a number of different shapes. For example, the shape of the terminal end 102 after welding may be a cube, cuboid, triangular prism, pentagonal prism, hexagonal prism, cylinder, and the like. Again, it should be understood that any type of shape could be utilized. Furthermore, the shape of the terminal end 102 may have edges that are either sharp or rounded.

With a further focus on FIG. 1C, the terminal end 102 of the cable 100 may also include a cap 104 that mates with the terminal end 102 of the cable 100. The cap 104 is generally made of a conductive material, such as copper. As such, the cap 104 may be made of the same material as the cable 100. The cap 104 receives the terminal end 102 of the cable 100. The cap 104 may be welded to the terminal end 102 during the same ultrasonic welding step utilized to consolidate the terminal end 102 of the cable 100 or may be welded in a two-step process, wherein the terminal end 102 is consolidated together using an ultrasonic welding process and then the cap 104 is then welded in a second ultrasonic welding process to the consolidated and 102 of the cable 100. Furthermore, the cap 104 may first be crimped using a crimping operation to the terminal end 102 before ultrasonic welding of the cap 104 to the terminal end 102 occurs.

The cap 104 can take any one of a number of different shapes. As such, the cap 104 may be a cube, cuboid, triangular prism, pentagonal prism, hexagonal prism, cylinder, and the like. Furthermore, as shown in FIG. 1C, the cap 104 may be an open-ended cap 104, sometimes referred to as a sleeve 104. As such, the terminal end 102 may have a portion that extends through the length of the sleeve 104.

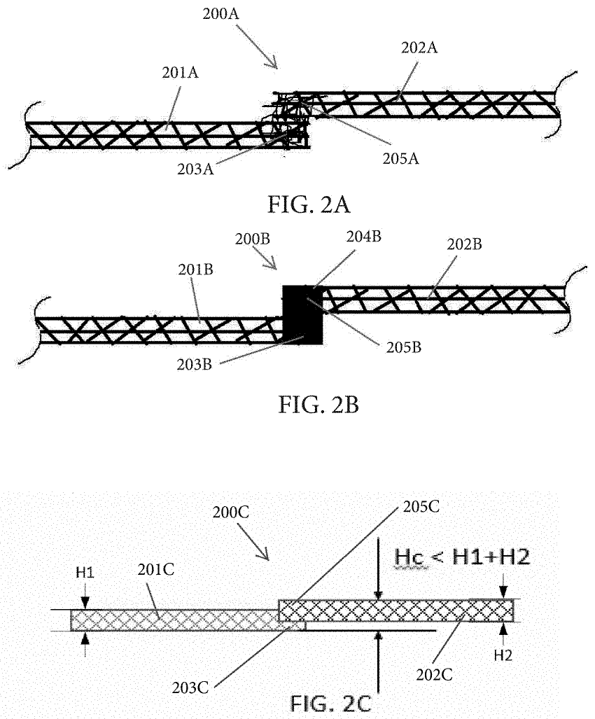

Referring to FIG. 2A, a cable 200A having a first multi-stranded wire 201A and a second multi-stranded wire 202A are shown. The first multi-stranded wire 201A and the second multi-stranded wire 202A each have terminal ends 203A and 205A. Here, the terminal ends 203A and 205A are placed on top of each other and joined to each other both physically and electrically via an ultrasonic welding process. The inventors have discovered that by ultrasonically welding the separate multi-stranded wires to each other, a cable may be developed that has excellent conductive properties between the first multi-stranded wire 201A and the second multi-stranded wire 202A.

Referring to FIG. 2B, a second version of the cable 200B is shown. Here, the cable 200B, like the cable 200A, is made up of a first multi-stranded wire 201B having a terminal end 203B and a second multi-stranded wire 202B having a terminal end 205B. The terminal ends 203B and 205B are placed on top one another and include a sleeve 204B that encloses portions of the terminal ends 203B and 205C. The terminal ends 203B and 205C are ultrasonically welded to each other using an ultrasonic welding process. The sleeve 204B may also be ultrasonically welded to the terminal ends 203B and 205B in the same process utilized to ultrasonically weld the terminal ends 203B and 205B to each other or by a separate process that occurs after the ultrasonic welding of the terminal ends 203B and 205C to each other.

Referring to FIG. 2C, a third example of the cable 200C is shown. Here, the cable 200C has a first multi-stranded wire 201C and a second multi-stranded wire 202C are shown. The first multi-stranded wire 201C and the second multi-stranded wire 202C each have terminal ends 203C and 205C. Here, the terminal ends 203C and 205C are to each other both physically and electrically via an ultrasonic welding process.

The first multi-stranded wire 201C may have a thickness of H1, while the second multi-stranded wire 202C may have a thickness of H2. The thicknesses H1 and H2 may be substantially equal to each other or may be different. When consolidating the first multi-stranded wire 201C and the second multi-stranded wire 202C using the ultrasonic welding process, the portions of the multi-stranded wires 201C and 202C that were consolidated to each other using the ultrasonic welding process may have a thickness of HC. The thickness HC will generally be less than the combined thickness H1 and H2. As such, the consolidated portions of the cable 200C have a thickness that is less than the combined thicknesses of the multi-stranded wires 201C and 202C. This may be advantageous in certain applications wherein the flexibility of the cable 200C is important. Additionally, this consolidation of the multi-stranded wires 201C and 202C using ultrasonic welding also yields a cable that has superior conductive properties.

There are numerous applications for the type of electrical cable described in the paragraphs above. For example, this electrical cable may be used in gas metal arc welding systems, electrical vehicle charging systems, power delivery systems wherein electrical power is transmitted from an electrical source to an electrical motor or another device that requires electricity, large electrical generators, server farms, green energy systems that seek to reduce parasitic losses of electricity, and a high amperage communication devices.

Additionally, because the electrical transmission properties of the electrical cable described in this document are superior to prior art systems, the electrical cable could also be used in more traditional lower amperage applications. In these such applications, because the electrical transmission is superior to prior art systems, less material making up the conductor may be utilized thus reducing costs and/or weight of the electrical cable. For example, extension cables could utilize the technology described in this application so that a lighter weight, more flexible but just as effective extension cable could be realized. It should be understood that the examples given above are just but a few examples regarding applications of the electrical cable shown described in this application.

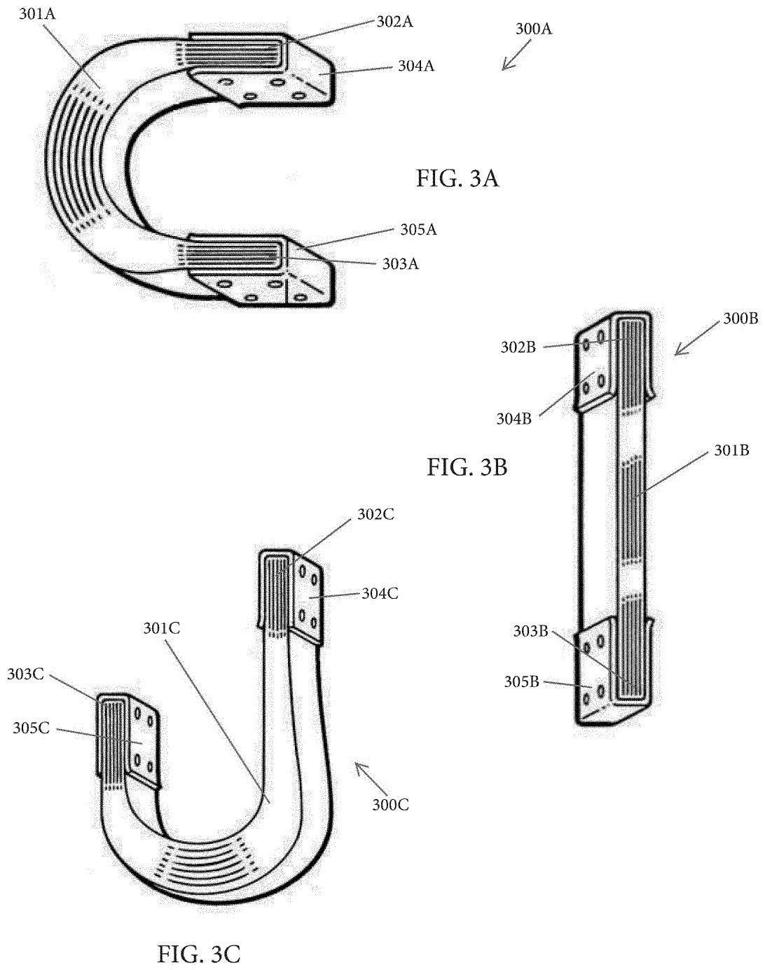

Referring to FIGS. 3A-3C, another example of the electrical conduit is shown. Here, these figures each illustrate shunt cables 300A, 300B, and 300C. Shunt cable 300A is a C-shaped shunt cable, shunt cable 300B is an I-shaped shunt cable, while shunt cable 300C is a J-shaped shunt cable. It should be understood that the shunt cables 300A, 300B, and 300C may take any one of a number of different shapes.

Each of the shunt cables, 300A, 300B, and 300C may be made of a plurality of conductive leaves 301A, 301B, and 301C, respectively. These conductive leaves 301A, 301B, and 301C are generally thin in nature and are flexible. The leaves 301A, 301B, and 301C may be solid strip of conductive material or may be a strip made of a braded multi-stranded wire. Each of the conductive leaves may be laid on top of each other. For the C-shaped shunt cable 300A and the J-shaped shunt cable 300C, some or even all the conductive leaves may have a different length. More so, the conductive leaves that are located interior to a circle formed by the C-shaped or the J-shape may be shorter in length than the conductive leaves further away from the interior of the circle formed by the C-shaped or the J-shape.

Each of the shunt cables 300A, 300B, and 300C have a first end 302A, 302B, and 302C, as well as a second end 303A, 303B, and 303C, respectively. The first end 302A, 302B, and 302C may be ultrasonically welded so as to ultrasonically weld each of the leaves at the end to each other. Additionally, the second end 303A, 303B, and 303C may be ultrasonically welded so as to ultrasonically weld each of the leaves at the end to each other. This ultrasonic welding process has the advantage of not only physically attaching each of the leaves to each other at each end, but also results in a superior conductive path formed at the end of each shunt cable.

Each of the shunt cables 300A, 300B, and 300C may also have a first sleeve 304A, 304B, and 304C attached to the first end 302A, 302B, and 302C, respectively. The sleeve 304A, 304B, and 304C may be a C-shaped sleeve that essentially clasps around first end 302A, 302B, and 302C, respectively. However, any type of sleeve may be utilized, including sleeves mentioned in FIGS. 1B, 1C, and 2B.

The sleeve 304A, 304B, and 304C may be ultrasonically welded to the first end 302A, 302B, and 302C, respectively, in the same operation that the first end 302A, 302B, and 302C is ultrasonically welded, or a separate operation occurs after the first end 302A, 302B, and 302C his ultrasonically welded.

Similarly, each of the shunt cables 300A, 300B, and 300C may also have a second sleeve 305A, 305B, and 305C attached to the second end 303A, 303B, and 303C, respectively. The sleeve 305A, 305B, and 305C may be a C-shaped sleeve that essentially clasps around second end 303A, 303B, and 303C, respectively. However, any type of sleeve may be utilized, including sleeves mentioned in FIGS. 1B, 1C, and 2B.

The sleeve 305A, 305B, and 305C may be ultrasonically welded to the second the end 303A, 303B, and 303C, respectively, in the same operation that the first end 303A, 303B, and 303C is ultrasonically welded, or a separate operation occurs after the second end 303A, 303B, and 303C his ultrasonically welded.

As a person skilled in the art will readily appreciate, the above description is meant as an illustration of an implementation of the principles of this invention. This description is not intended to limit the scope or application of this invention in that the invention is susceptible to modification, variation, and change, without departing from the spirit of this invention, as defined in the following claims.

1. A cable for transmitting electricity, the cable comprising:
a first end of the cable and a second end of the cable, wherein the cable is formed from a multi-stranded wire or a plurality of conductive leaves; and
wherein the first end of the cable is consolidated via an ultrasonic welding process.

2. The cable of claim 1, wherein the second end of the cable is consolidated via the ultrasonic welding process.

3. The cable of claim 1, further comprising a sleeve substantially enclosing a portion of the first end of the cable.

4. The cable of claim 3, wherein the first end of the cable and the sleeve is consolidated via the ultrasonic welding process.

5. The cable of claim 3, wherein the first end of the cable and the sleeve are consolidated via separate ultrasonic welding processes.

6. The cable of claim 1, wherein the cable is configured to be utilized in at least one of the following applications: gas metal arc welding systems, electrical vehicle charging systems, power delivery systems wherein electrical power is transmitted from an electrical source to an electrical motor or another device that requires electricity, large electrical generators, server farms, green energy systems that seek to reduce parasitic losses of electricity, and a high amperage communication devices.

7. A welding cable for transmitting electricity, the welding cable comprising:
a cable body having a first end and a second end, the cable body comprising multi-stranded wire or a plurality of conductive leaves; and
wherein the first end of the cable body is consolidated via an ultrasonic welding process.

8. The cable of claim 7, wherein the second end of the cable body is consolidated via the ultrasonic welding process.

9. The cable of claim 7, further comprising a sleeve substantially enclosing a portion of the first end of the cable body.

10. The cable of claim 9, wherein the sleeve comprises a C-shaped sleeve that clasps around the first end.

11. The cable of claim 9, wherein the first end of the cable body and the sleeve are consolidated via the ultrasonic welding process.

12. The cable of claim 9, wherein the first end of the cable body and the sleeve are consolidated via separate ultrasonic welding processes.

13. The cable of claim 7, wherein the cable body is the plurality of conductive leaves and the leaves are solid strips of conductive material.

14. The cable of claim 13, wherein some of the leaves are longer than other leaves causing a bend in the cable.

15. The cable of claim 14, wherein the cable forms a J shape.

16. The cable of claim 14, wherein the cable forms a C shape.

17. The cable of claim 7, wherein the first end of the cable body is consolidated via the ultrasonic welding process together with an end of a separate cable.

18. The cable of claim 17, wherein the first end of the cable body and the end of the separate cable become one solid consolidated portion.

19. The cable of claim 18, where in the separate cable comprises multi-stranded wire or a plurality of conductive leaves.

20. The cable of claim 19, wherein another end of the separate cable is consolidated via an ultrasonic welding process.
